(19) United States
(12) Patent Application Publication
(10) Pub. No.: US 2020/0385510 A1
(43) Pub. Date: Dec. 10, 2020

(54) METHOD FOR PRODUCING OPEN-CELL RIGID FOAMS COMPRISING URETHANE GROUPS AND ISOCYANURATE GROUPS

(71) Applicant: BASF, Ludwigshafen am Rhein (DE)

(72) Inventors: Joerg KROGMANN, Lemfoerde (DE); Johann KLASSEN, Lemfoerde (DE); Hendrik WAGNER, Lemfoerde (DE)

(73) Assignee: BASF, Ludwigshafen am Rhein (DE)

(21) Appl. No.: 16/764,191

(22) PCT Filed: Dec. 5, 2018
(86) PCT No.: PCT/EP2018/083571

§ 371 Date: May 14, 2020

(30) Foreign Application Priority Data
Dec. 5, 2017 (EP) 17205446.2

(51) Int. Cl. C08G 18/76; C08G 18/66; C08G 18/48; C08G 18/32; C08J 9/12

(52) U.S. Cl. CPC C08G 18/7664; C08G 18/6677; C08G 2101/0083; C08G 18/3206; C08J 9/125; C08G 18/4845

(57) ABSTRACT

The invention provides a process for producing an open-cell rigid polyurethane foam by a slabstock foam process and also provides for the use of the rigid polyurethane foam obtained in vacuum insulation panels.

The invention provides a process for producing an open-cell rigid polyurethane foam by a slabstock foam process by reacting a reaction mixture comprising
a. one or more polyisocyanates;
b. one or more compounds comprising groups reactive towards isocyanate groups and having a functionality between 1.9 to 8;
c. one or more catalysts; and
d. blowing agents;
e. in the presence of a stabilizer e2) and a cell opener e1), where the stabilizer e2) is preferably a polyether-polydimethylsiloxane copolymer and the cell opener e1) is a mixture of macromolecular unsaturated hydrocarbons with an ester, and the weight ratio of cell opener e1) to stabilizer e2) is at least 0.2;
   wherein
i. more than 1% by weight, based on the total weight of component b), of at least one compound b-1) is used as a chain extender and/or crosslinking agent, selected from the group of the alkanolamines, diols and/or triols having molecular weights of less than 400 and a functionality between 2 to 3;
ii. the only blowing agent (d) used is a chemical blowing agent or a mixture of chemical blowing agents; and
iii. the isocyanate index is in the range from 130 to 215.

Rigid polyurethane foams have long been known. A significant area of use is thermal insulation. More recently, vacuum insulation panels have also been increasingly used for insulation. Such vacuum insulation units generally consist of a thermally insulating core material, for example open-cell rigid polyurethane (PUR) foam, open-cell extruded polystyrene foam, silica gels, glass fibers, beds of loose plastics particles, pressed ground material made from rigid or semirigid PUR foam or perlites, which is packed into a gas-tight film, evacuated and sealed by welding so as to be airtight.

Vacuum insulation units are used, inter alia, for housings of refrigeration equipment, containers for refrigerated vehicles or district heating pipes. On account of their lower thermal conductivity, they offer advantages over conventional insulating materials. For instance, the energy savings potential compared to closed-cell rigid polyurethane foams is about 20% to 30%.

In a further embodiment, vacuum insulation units can be produced via introduction of a foam system for open-cell rigid polyurethane foams into the interior of the double wall of a double-walled housing, for example of a refrigerator door or a refrigerator housing, where the system cures to give an open-cell foam, and subsequent evacuation. In this embodiment, a vacuum pump can be connected to the foam-filled double wall, via which the vacuum can be regenerated when necessary.

When using rigid polyurethane foams for such applications, it is essential that the cells of the foam are open, in order to achieve complete evacuation of the vacuum insulation panel. A range of possibilities are known for this.

DE 19917787 describes a process for producing compressed rigid polyurethane foams and WO 0047647 discloses a process for producing fine-celled rigid polyurethane foams. EP 0581191 relates to a process for producing open-cell polyurethane foams; U.S. Pat. No. 5,889,067 likewise describes a method for creating an open-cell rigid polyurethane foam. US 2002045690 discloses a pultrusion process using polyisocyanurates.

EP 905 159 and EP 905 158 disclose processes for producing open-cell rigid foams, an esterification product of fatty acids and polyfunctional alcohols preferably being used as emulsifying agent for aiding the storage-stable blowing agent-containing emulsion. Here, combinations of perfluoroalkanes and alkanes are used in particular as physical blowing agents. The use of perfluoroalkanes for producing fine cells is already known from EP 351 614. DE 100 09 649 describes a process for producing open-cell rigid foams in which the use of physical blowing agents can be dispensed with. Production of these foams involves the use of a polyol component which in addition to an esterification product of glycerol and castor oil comprises further polyether alcohols having a hydroxyl number in the range from 175 to 300 mg KOH/g which are customary for the production of rigid polyurethane foams. The foams described in this document display a good open-cell content and adequate mechanical properties.

One option for producing the open-cell rigid polyurethane foams used as a core material for vacuum insulation panels is what is known as the slabstock foam process. Such a process has been described for example in WO 99/61503. This involves producing large foam blocks, usually having a size of 0.5×1.2×2 meters, and mechanically bringing them to the desired size, usually by sawing. This procedure is very effective. However, a disadvantage is that due to the exothermicity of the urethane reaction there is frequently an elevated temperature within the blocks, which can result in increased cracking in the foam and in an extreme case to thermal decomposition up to and including combustion within the block.

In WO 99/61503, the rigid foams are produced in the presence of a cyclic, isocyanate-reactive urea compound. However, only rigid foam blocks having a low height, of up to at most 50 cm, can be produced by this process. Since during slabstock foaming a skin having closed cells always forms on the edges of the blocks and has to be removed, the smaller the block, the greater the waste. For this reason, taller blocks are more efficient. In addition, larger vacuum insulation panels do not need to be assembled from a plurality of PUR sheets, which likewise represents an economic advantage.

In the wake of this problem, EP 2 072 548 A describes a process for producing open-cell rigid polyurethane foams using the slabstock foam process even at low foaming temperatures, with the blowing agent used being a mixture of water and at least one physical blowing agent, as a result of which materials having good mechanical properties are obtained. The rigid polyurethane foams obtained here have good curing properties, cracking in the foams has been avoided, and the foams have not only mechanical but also advantageous and thermal insulation properties.

However, the use of physical blowing agents such as defined in EP 2 072 548 A is disadvantageous for ecological and economic reasons and does not constitute a sustainable solution. However, precisely the use of the physical blowing agent results not only in the advantageous foam formation necessary for the use in vacuum insulation panels but also enables the performance of the process at low temperatures, since when using water as the sole blowing agent the exothermicity of the reaction rises significantly, which in an extreme case can even lead to thermal decomposition processes in the foam.

It was therefore an object of the present invention to develop a process for producing open-cell rigid polyurethane foams using the slabstock foam process at the lowest possible foaming temperatures, the only blowing agents used being chemical blowing agents, preferably water. The open-cell rigid polyurethane foams obtained by this process should display at least the same, but preferably better, mechanical properties with a markedly more sustainable, and simple, process regime without the addition of physical blowing agents. Here, adverse effects within the rigid PUR foam blocks, such as cracking and thermal decomposition within the slabstock foam, that are caused by the exothermicity of the urethane reaction are intended to be avoided. For use in vacuum insulation panels, the rigid PUR foams must also have the maximum possible level of open-cell content and also good evacuability, so that the rigid PUR foams can be evacuated as completely as possible within reasonable periods of time.

The object was surprisingly achieved by a process for producing an open-cell rigid polyurethane foam by a slabstock foam process by reacting a reaction mixture comprising
a. one or more polyisocyanates;
b. one or more compounds comprising groups reactive towards isocyanate groups and having a functionality between 1.9 to 8;
c. one or more catalysts; and
d. blowing agents;
e. in the presence of a stabilizer e2) and a cell opener e1), where the stabilizer e2) is preferably a polyether-polydimethylsiloxane copolymer and the cell opener e1) is a mixture of macromolecular unsaturated hydrocarbons with an ester, and the weight ratio of cell opener e1) to stabilizer e2) is at least 0.2;
   wherein
i. more than 1% by weight, based on the total weight of component b), of at least one compound b-1) is used as a chain extender and/or crosslinking agent, selected from the group of the alkanolamines, diols and/or triols having molecular weights of less than 400 g/mol and a functionality between 2 to 3;
ii. the only blowing agent (d) used is a chemical blowing agent or a mixture of chemical blowing agents; and
iii. the isocyanate index is in the range from 130 to 215.

Component b-1) is selected from the group of the alkanolamines, diols and/or triols having molecular weights of less than 400 g/mol and a functionality between 2 to 3.

Examples of suitable alkanolamines are mono, di- or tri-C₁-C₄-alkanolamines or methyl-C₁-C₄-alkanolamines, for example ethanolamine, diethanolamine, triethanolamine, propanolamine, N,N-diethanolpropanamine, butanolamine, N,N-diethanolbutanamine, N-methylethanolamine, N-ethyldiethanolamine, N-methyldiethanolamine, N-methylpropanamine, N-methyl-N-ethanolpropanamine, N-methylbutanamine, N-methyl-N-ethanolbutanamine or mixtures of the alkanolamines mentioned above.

Examples of suitable triols are glycerol (molecular weight 92.1 g/mol) and trimethylolpropane (molecular weight 134.2 g/mol).

Examples of suitable diols are monoethylene glycol, propane-1,2- and -1,3-diol, butane-1,2-, -1,3-, -1,4- and -2,3-diol, pentanediols, hexanediols, diethylene glycol, triethylene glycol, dipropylene glycol and tripropylene glycol.

Preference is given to diols or alkanolamines having molecular weights of less than 400 g/mol, preferably a molecular weight of 60 to 300 g/mol.

Very particular preference is given to diols having molecular weights of less than 400 g/mol, preferably a molecular weight of 60 to 300 g/mol.

Based on the total weight of component b), the proportion of component b-1) is at least 1% by weight, preferably more than 1% by weight, more preferably at least 1.1% by weight, more preferably still at least 1.5% by weight and particularly preferably at least 2.0% by weight. Preferred ranges are 1% to 5% by weight, particularly preferably 1.5% by weight to 4% by weight, very particularly preferably at least 2.0% by weight to 3.5% by weight.

As stated above, the rigid foams produced by the process according to the invention are open-cell. The term “open-cell” is understood within the context of the present invention to mean that at least 80%, preferably at least 90% and particularly preferably at least 95% of the cells of the foam are open. The open-cell content is determined according to DIN ISO 4590.

In a preferred embodiment of the process according to the invention, the rigid foams producible by the process according to the invention comprise not only urethane groups but also isocyanurate groups. Such foams are frequently also referred to as polyisocyanurate foams (PIR foams).

The polyisocyanates (a) used may include any aliphatic, cycloaliphatic and aromatic di- or polyfunctional isocyanates known from the prior art and any desired mixture of these. Aromatic di- or polyfunctional isocyanates are preferably used. Examples are diphenylmethane 4,4′-, 2,4′-, and 2,2′-diisocyanate (MDI), mixtures of monomeric diphenylmethane diisocyanates and higher polycyclic homologs of diphenylmethane diisocyanate (polymer MDI), tetramethylene diisocyanate, hexamethylene diisocyanate (HDI), isophorone diisocyanate (IPDI), naphthalene 1,5-diisocyanate (NDI), toluene 2,4,6-triisocyanate and toluene 2,4- and 2,6-diisocyanate (TDI), or mixtures thereof.

Particular preference is given to using aromatic isocyanates selected from the group consisting of toluene 2,4-diisocyanate, toluene 2,6-diisocyanate, diphenylmethane 2,4′-diisocyanate and diphenylmethane 4,4′-diisocyanate and higher polycyclic homologs of diphenylmethane diisocyanate (polymer MDI), and mixtures of these. The isocyanate used is in particular an aromatic isocyanate selected from the group consisting of diphenylmethane 2,4′-diisocyanate, diphenylmethane 4,4′-diisocyanate, higher polycyclic homologs of diphenylmethane diisocyanate or mixtures of two or more of these compounds.

In addition to the polyalcohols b-1), further compounds having at least two hydrogen atoms reactive towards isocyanate groups, such as polyols, are typically also present in component b). Compounds used having at least two hydrogen atoms reactive towards isocyanate groups are usually polyether alcohols and/or polyester alcohols, referred to hereinafter as polyols b-2), especially polyether alcohols. The reaction mixture preferably comprises at least one further polyol b-2); component b) particularly preferably consists of components b-1) and b-2).

Useful compounds having at least two hydrogen atoms reactive towards isocyanate groups include those comprising at least two reactive groups, for example OH and NH groups, preferably OH groups, in particular polyether alcohols and/or polyester alcohols having OH numbers in the range from 25 to 800 mg KOH/g.

The polyester alcohols used are usually prepared by condensation of polyfunctional alcohols, preferably diols, having 2 to 12 carbon atoms, preferably 2 to 6 carbon atoms, with polyfunctional carboxylic acids having 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and isomeric naphthalenedicarboxylic acids.

The polyester alcohols used typically have a functionality in the range from 1.5 to 4.

In particular, polyether alcohols are used which are prepared by known processes, for example by anionic polymerization of alkylene oxides on H-functional starter substances in the presence of catalysts, preferably alkali metal hydroxides or double metal cyanide catalysts (DMC catalysts).

The alkylene oxides used are usually ethylene oxide or propylene oxide, but also tetrahydrofuran, various butylene oxides, styrene oxide, preferably pure 1,2-propylene oxide. The alkylene oxides may be used individually, alternately in succession or as mixtures.

The starter substances used are in particular compounds having at least 2, preferably 2 to 8, hydroxyl groups or having at least one primary amino group in the molecule. Starter substances used having at least 2, preferably 2 to 8, hydroxyl groups in the molecule are preferably trimethylolpropane, glycerol, pentaerythritol, sugar compounds such as for example glucose, sorbitol, mannitol and sucrose, polyhydric phenols, resols, for example oligomeric condensation products of phenol and formaldehyde and Mannich condensates of phenols, formaldehyde and dialkanolamines and also melamine.

Starter substances used having at least one primary amino group in the molecule are preferably aromatic di- and/or polyamines, for example phenylenediamines, and 4,4′-, 2,4′- and 2,2′-diaminodiphenylmethane, and aliphatic di- and polyamines such as ethylenediamine. Ethanolamine or toluenediamines are also suitable.

The polyether alcohols have a functionality of preferably 2 to 8 and hydroxyl numbers of preferably 25 mg KOH/g to 800 mg KOH/g and in particular 150 mg KOH/g to 570 mg KOH/g.

As described, the chain extenders and/or crosslinking agents b-1) and polyols b-2) are mixed in a ratio such that the required values for functionality and hydroxyl number are achieved.

The rigid foams are typically produced in the presence of catalysts (c), blowing agents (d) and cell stabilizers (e) and also, if necessary, further auxiliaries and/or additives such as for example flame retardants.

The catalysts (c) used are in particular compounds which strongly accelerate the reaction of the isocyanate groups with the groups reactive towards isocyanate groups. Examples of such catalysts are basic amines such as secondary aliphatic amines, imidazoles, amidines, alkanolamines, Lewis acids or organometallic compounds, especially those based on tin or bismuth. Catalyst systems consisting of a mixture of various catalysts can also be used.

Isocyanurate catalysts used are typically metal carboxylates, especially potassium formate, potassium octanoates or potassium acetate and solutions of these. Depending on requirements, the catalysts can be used alone or in any desired mixtures with one another.

The blowing agents (d) used in the present invention are solely chemically active blowing agents. “Chemical blowing agents” is understood to mean compounds that form gaseous products by reaction with isocyanate. In this case, a chemical blowing agent or a mixture of chemical blowing agents may be used. Preferred chemical blowing agents are water or acids, in particular formic acid or mixtures of water and acids. The chemical blowing agent (d) is particularly preferably selected from water and mixtures of water with one or more further chemical blowing agents; the chemical blowing agent is very particularly preferably water.

In a preferred embodiment of the present invention, the amount of the blowing agent is at least 1% by weight, based on the total weight of components b), c), d) and e) used, particular preference being given to selecting the range from 1% to 6% by weight, very particularly preferably 1.5% to 6% by weight.

Useful auxiliaries and/or additives are the substances known per se for this purpose, for example surface-active substances, foam stabilizers, cell regulators, fillers, pigments, dyes, antioxidants, hydrolysis stabilizers, antistats, fungistatic and bacteriostatic agents.

More detailed information regarding the starting materials, blowing agents, catalysts and auxiliaries and/or additives used to carry out the process according to the invention can be found, for example, in the Kunststoffhandbuch [Plastics Handbook], volume 7, “Polyurethane [Polyurethanes]” Carl-Hanser-Verlag Munchen, 1st edition, 1966, 2nd edition, 1983 and 3rd edition, 1993.

As stated above, the open-cell content is an essential feature of the rigid foams produced by the process according to the invention. This is necessary in order to enable evacuation when producing the vacuum insulation panels. In addition, the open-cell content prevents an excessive thermal stress on the foams during production. Cell openers e1) are used to increase the number of open cells. These are preferably compounds which influence the surface tension of the components during the foaming. The cell openers e1) used are preferably esters, particularly preferably esters of carboxylic acids, in combination with macromolecular, unsaturated hydrocarbons, where the cell opener e1) used can advantageously be a mixture of macromolecular unsaturated hydrocarbons with a phthalic ester. This mixture is frequently stabilized with amines. A cell opener e1) or a mixture of cell openers e1) can be used.

The stabilizers e2) also have a great influence on the open-cell content of the by way of polyether-polydimethylsiloxane copolymers foams having a high content with open cells can be obtained. Examples of suitable stabilizers are Tegostab B 8870 from Evonik, which promotes cell opening. A stabilizer e2) or a mixture of stabilizers e2) can be used.

It is particularly advantageous to use a mixture of macromolecular, unsaturated hydrocarbons with a phthalic ester as cell opener e1) and polyether-polydimethylsiloxane copolymers as stabilizer e2). These can preferably be used in an amount of 0.5% to 5.0% by weight, based on the weight of component b). The weight ratio of e1) to e2) according to the invention is at least 0.2, preferably in the range from 0.2 to 10, more preferably in the range from 0.2 to 7 and particularly preferably in the range from 0.2 to 5. It is also possible for the weight ratio of e1) to e2) to be in the range from 0.2 to 3.

In the industry, components b), c), d) and e) are frequently mixed to give what is called a polyol component and reacted in this form with the polyisocyanates a).

As stated above, when producing the foams by the process according to the invention, the polyisocyanate and the compounds having at least two hydrogen atoms reactive towards isocyanate groups are reacted at an isocyanate index in the range from 130 to 215. In a preferred embodiment, the polyisocyanate and the compounds having at least two hydrogen atoms reactive towards isocyanate groups are reacted at an isocyanate index in the range from 150 to 215, particularly preferably from 180 to 210.

The foams are preferably produced, as described, in the slabstock foaming process. The slabstock foaming process is generally a discontinuous process in which large blocks, for example 2 m×1.2 m×1.2 m, are produced via relatively slow-reacting foam systems. To this end, the polyol component and the polyisocyanate a) are mixed and this mixture is introduced into a mold in which it cures to give the foam. The size of the mold depends on the intended size of the foam block. After curing the foam, the block is removed from the mold. It can then be cut up into the pieces required for producing the vacuum insulation panels, preferably by sawing. To this end, commercially available band and wire saws are/can be used. When foaming, the mold is preferably lined with a film before the foaming in order to prevent wetting and hence adhesion of the foam to the mold wall. In the case of the slabstock foaming process, the reaction mixture is free-foamed, that is to say the foam that is forming is not confined in all dimensions, but instead it can expand freely in at least one dimension.

A stationary molding technique consisting of a plurality of molds and a/a plurality of mixing station(s), usually stirrers, mixing units such as low-pressure mixing heads, can also be used, as can a carousel technique (molds on carousels), in which mixing is generally effected centrally with a mixing station/unit in one position.

The open-cell rigid polyurethane foams according to the invention that are obtained have a density of 30 to 100 g/I, preferably of 40 to 80 g/I. The density is determined by determining the weight of a cube cut out from a foam block and having an edge length of at least 10 cm.

The vacuum insulation panels are produced, as described above, by enveloping the open-cell rigid polyurethane foam with a gas-impermeable film, welding this shut and evacuating it.

The process according to the invention makes it possible in a simple manner to produce open-cell rigid polyurethane foams which have a high open-cell content and good mechanical properties and can be processed into vacuum insulation panels. Surprisingly, there is no overheating or thermal damage to the foams as would normally be expected from the use of water as blowing agent.

The present invention further provides an open-cell rigid polyurethane foam obtainable by the process according to the invention and also to the use of an open-cell rigid polyurethane foam produced by the process according to the invention as a core material of vacuum insulation panels.

The invention will be illustrated in more detail by the examples which follow.

### EXAMPLES

Measurement Methods:

Measurement of Hydroxyl Number:

Hydroxyl numbers are determined according to DIN 53240 (1971-12).

Viscosity Determination:

The viscosity of the polyols is determined, unless specified otherwise, at 25° C. according to DIN EN ISO 3219 (1994) using a Haake Viscotester 550 with plate/cone measurement geometry (PK100) using the PK 1 1° cone (diameter: 28 mm; cone angle: 1°) at a shear rate of 40 1/s.

Compressive Strength:

Compressive strength is determined according to DIN ISO 844 EN DE (2014-11).

Open-Cell Content (OC) The determination of the open-cell content with corresponding measurement time was obtained in accordance with DIN EN ISO 4590.

Foam Density

The foam density was determined by measuring the foam density in the core in accordance with DIN EN ISO 845.

Starting Materials

a) Isocyanate (Polymer MDI)

Isocyanate 1 Lupranat® M20 NCO content=31.8 g/100 g from BASF

b) Polyols
Polyol 1 (b-2): OH number=490; prepared by addition of propylene oxide onto sucrose, and glycerol
Polyol 2 (b-2): OH number=105; prepared by addition of propylene oxide onto propylene glycol
Polyol 3 (b-2): OH number=250; prepared by addition of propylene oxide onto propylene glycol
Polyol 4 (b-1): Monoethylene glycol (MEG) as chain extender
Polyol 5 (b-1): Glycerol as chain extender
Polyol 6 (b-2): OH number=490; prepared by addition of propylene oxide onto sorbitol
Polyol 7 (b-2): OH number=42, prepared by addition of propylene oxide and ethylene oxide onto glycerol

c) Catalysts

Catalyst 1 (c-1): Polycat® 58 (Evonik)

Catalyst 2 (c-2): Potassium acetate in MEG, 47% by weight (BASF)

Catalyst 3 (c-3): Dimethylcyclohexylamine (DMCHA)

d) Blowing Agents:

Water (d-1)

Cyclopentane 70: cyclopentane/isopentane (70:30%) (physical blowing agent)

f) Additives:

Stabilizer (e2): Tegostab® B8870 from Evonik (stabilizer)

Cell opener (e1): Ortegol® 501 from (Evonik)

Components a) to e) were mixed to give a polyol component and reacted with the isocyanate. The amounts of the feedstocks used can be found in table 1. C denotes comparative examples, IE denotes inventive examples. Mixing was effected in a mixing head (for example low-pressure or high-pressure process, the processing of IE 7 was effected in the high-pressure process) or by means of stirring in a reservoir vessel. The reaction mixture was discharged into a laboratory mold having side lengths 418 mm×700 mm×455 mm and allowed to cure there.

TABLE 1

| | | C1 | C2 | IE1 | IE2 | IE3 | C3 | C4 | IE4 |
|---|---|---|---|---|---|---|---|---|---|
| Polyol 1 (b-2) | [wt. %] | 40.1 | 42.7 | 41.3 | 41.3 | 41.2 | 41.3 | 41.9 | 41.5 |
| Polyol 2 (b-2) | [wt. %] | 40.1 | 42.7 | 41.3 | 41.3 | 41.2 | 41.3 | 41.9 | 41.5 |
| Polyol 3 (b-2) | [wt. %] | 8.3 | 8.9 | 8.6 | 8.6 | 8.6 | 8.6 | 8.7 | 8.6 |
| Polyol 4 (*) (b-1) | [wt. %] | — | — | 2.7 | 2.7 | 2.7 | 2.7 | 0.95 | 1.9 |
| Polyol 5 (b-1) | [wt. %] | — | — | — | — | — | — | — | — |
| Polyol 6 (b-2) | [wt. %] | — | — | — | — | — | — | — | — |
| Polyol 7 (b-2) | [wt. %] | — | — | — | — | — | — | — | — |
| Catalyst 1 (c-1) | [wt. %] | 0.45 | 0.5 | 0.29 | 0.29 | 0.39 | 0.29 | 0.47 | 0.47 |
| Catalyst 2 (ⁱ) (c-2) | [wt. %] | 0.64 | 0.7 | 0.93 | 0.93 | 0.93 | 0.93 | 0.95 | 0.94 |
| Catalyst 3 (c-3) | [wt. %] | — | — | — | — | — | — | — | — |
| Cyclopentane 70 | [wt. %] | 6.8 | — | — | — | — | — | — | — |
| Water (d-1) | [wt. %] | 0.5 | 1.26 | 1.66 | 1.66 | 1.85 | 1.66 | 1.95 | 1.93 |
| Cell regulators (e) | | | | | | | | | |
| Stabilizer (e2) | [wt. %] | 0.82 | 0.87 | 0.83 | 0.83 | 0.83 | 0.83 | 0.85 | 0.85 |
| Cell opener (e1) | [wt. %] | 2.27 | 2.42 | 2.34 | 2.34 | 2.34 | 2.34 | 2.37 | 2.35 |

Reaction parameters:

| | | | | | | | | | |
|---|---|---|---|---|---|---|---|---|---|
| Index | | 244 | 225 | 202 | 200 | 210 | 240 | 200 | 200 |
| Sum of | [wt. %] | 100 | 100 | 100 | 100 | 100 | 100 | 100 | 100 |
| b + c + d + e) | | | | | | | | | |
| (*) Component b-1) | [wt. %] | 0.34 | 0.37 | 3.22 | 3.22 | 3.22 | 3.22 | 1.45 | 2.38 |
| Ratio of e1:e2 | | 2.8 | 2.8 | 2.8 | 2.8 | 2.8 | 2.8 | 2.8 | 2.8 |
| Isocyanate 1 | [wt. %] | 100 | 100 | 100 | 100 | 100 | 100 | 100 | 100 |
| Cream time: | [s] | 55 | 55 | 55 | 35 | 55 | 70 | 45 | 47 |
| Fiber time | [s] | 225 | 240 | 162 | 100 | 190 | 200 | 185 | 175 |
| Core density | [kg/m³] | 67.5 | 87.2 | 65.9 | 55 | 64.6 | 76.3 | 60.8 | 60.3 |

Experimental results:

| Tmax | [° C.] | 147 | 164 | 180 | 190.1 | 169.6 | 172.3 | 165.6 | 168.7 |
|---|---|---|---|---|---|---|---|---|---|
| OC (corr) | [%] | 93 | 19 | 95 | 100 | 93 | 99 | 78 | 91 |
| Measurement | [s] | 1100 | 926 | 674 | 344 | 550 | 589 | 1708 | 821 |
| time for OC | | | | | | | | | |
| Mixing | | iii) | iii) | iii) | iv) | iii) | iii) | iii) | iii) |
| Core discoloration | | no | no | no | no | no | yes | no | no |
| | | IE5 | C5 | IE6 | IE7 | IE8 | IE9 | C6 | C7 |
| Polyol 1 (b-2) | [wt. %] | 41.3 | 43.7 | 42.2 | 43.5 | 39.7 | 41.8 | — | — |
| Polyol 2 (b-2) | [wt. %] | 41.3 | 41.3 | 41.3 | 41.3 | 41.3 | 41.3 | 20.0 | 20.0 |
| Polyol 3 (b-2) | [wt. %] | 8.6 | 8.6 | 8.6 | 8.6 | 8.6 | 8.6 | — | — |
| Polyol 4 (*) (b-1) | [wt. %] | — | 2.7 | 2.7 | 2.7 | 2.7 | 2.7 | — | — |
| Polyol 5 (b-1) | [wt. %] | 2.7 | — | — | — | — | — | — | — |
| Polyol 6 (b-2) | [wt. %] | — | — | — | — | — | — | 48.8 | 47.9 |
| Polyol 7 (b-2) | [wt. %] | — | — | — | — | — | — | 25.0 | 25.0 |
| Catalyst 1 (c-1) | [wt. %] | 0.29 | 0.29 | 0.29 | 0.29 | 0.29 | 0.29 | — | — |
| Catalyst 2 (ⁱ) (c-2) | [wt. %] | 0.93 | 0.93 | 0.93 | 0.93 | 0.93 | 0.93 | 0.08 | 0.08 |
| Catalyst 3 (c-3) | [wt. %] | — | — | — | — | — | — | 0.5 | 0.5 |
| Cyclopentane 70 | [wt. %] | — | — | — | — | — | — | — | — |
| Water (d-1) | [wt. %] | 1.66 | 1.95 | 1.66 | 1.66 | 1.66 | 1.2 | 1.66 | 1.66 |
| Cell regulators (e) | | | | | | | | | |
| Stabilizer (e2) | [wt. %] | 0.83 | 0.83 | 0.83 | 0.83 | 0.83 | 0.83 | — | 0.9 |
| Cell opener (e1) | [wt. %] | 2.34 | — | 1.5 | 0.13 | 4 | 2.34 | 4 | 4 |
| Reaction parameters: | | | | | | | | | |
| Index | | 200 | 200 | 200 | 200 | 200 | 200 | 160 | 160 |
| Sum of | [wt. %] | 100 | 100 | 100 | 100 | 100 | 100 | 100 | 100 |
| b + c + d + e) | | | | | | | | | |
| (*) Component b-1) | [wt. %] | 0.49 | 3.22 | 3.22 | 3.22 | 3.22 | 3.22 | 0.04 | 0.04 |
| Ratio of e1:e2 | | 2.8 | — | 1.8 | 0.2 | 4.8 | 2.8 | — | 4.4 |
| Isocyanate 1 | [wt. %] | 100 | 100 | 100 | 100 | 100 | 100 | 100 | 100 |
| Cream time: | [s] | 70 | 70 | 70 | 70 | 65 | 55 | ii) | 40 |
| Fiber time | [s] | 202 | 168 | 172 | 170 | 169 | 148 | | 190 |
| Core density | [kg/m³] | 71.4 | 61.2 | 62.7 | 60.9 | 67.6 | 78.5 | | 66.6 |
| Experimental results: | | | | | | | | | |
| Tmax | [° C.] | 175.2 | 179 | 179 | 179 | 178.5 | 180 | | 145 |
| OC (corr) | [%] | 100 | 43 | 100 | 100 | 100 | 100 | | 15 |
| Measurement | [s] | 469 | 1843 | 470 | 986 | 493 | 492 | | 1117 |
| time for OC | | | | | | | | | |
| Mixing | | iii) | iii) | iii) | iii) | iii) | iii) | iii) | iii) |
| Core discoloration | | no | no | no | no | no | no | | no |

i) the actual MEG content is increased due to the amount in catalyst 2

ii) the foam collapses and as a result no PUR foam was obtained

iii) mixing in a reservoir vessel

iv) high-pressure mixing

To determine the course of curing, small foam blocks were foamed in a laboratory mold having a volume of approx. 0.5 dm³. The machine test was effected by foaming in a wooden mold of approx. 1500 l. The examples according to the invention show that it is possible to produce open-cell PUR/PIR foams based on chemical blowing agents (implementation examples IE 1 and 2). A sufficient open-cell content is necessary for vacuum and VIP applications. This can be achieved in particular by the use of chain extender polyols of the type b-1). The use of excessively small amounts (C4) leads to a reduced open-cell content.

The prerequisite for producing slabstock foams is that there is no core discoloration, since this leads to a deterioration of the properties and especially to an increased risk of fire. The maximum core temperature in combination with the resulting density is crucial here in particular.

Both cell openers (e1) and stabilizers (e2) have to be present, since otherwise either no open-cell rigid PUR foam or no rigid PUR foam at all is obtained, see C5 and C6. In this case the ratio of cell opener (e1) to stabilizer (e2) should also be taken into account, since this is important for the open-cell content and accessibility of the open cells. The accessibility of the open cells can be read from the measurement time for the level of open-cell content. The ratio of cell opener (e1) to stabilizers (e2) in this case has to exceed a minimum, see IE 8, IE 6 and 1E7, since otherwise an excessive amount of time is required for evacuating the rigid PUR foam.

1. A process for producing an open-cell rigid polyurethane foam, the process comprising:
performing a slabstock foam process by reacting a reaction mixture comprising
a. a polyisocyanate;
b. a compound comprising a group reactive towards at least one isocyanate group and having a functionality between 1.9 to 8;
c. a catalyst; and
d. a blowing agent;
e. in the presence of a stabilizer e2) and a cell opener e1),
wherein the cell opener e1) is a mixture of at least one macromolecular unsaturated hydrocarbon with an ester, and a weight ratio of the cell opener e1) to the stabilizer e2) is at least 0.2; and
wherein
i. the component b) comprises more than 1% by weight, based on a total weight of the component b), of a chain extender and/or crosslinking agent as the compound b-1) wherein the chain extender and/or crosslinking agent is at least one selected from the group consisting of an alkanolamine, a diol and triol, having a molecular weight of less than 400 g/mol and a functionality between 2 to 3 and
ii. the blowing agent is a chemical blowing agent or a mixture of chemical blowing agents, and
iii. an isocyanate index is from 130 to 215.

2. The process according to claim 1, wherein the component b-1) is a diol or triol.

3. The process according to claim 1, wherein the component b-1) is a diol.

4. The process according to claim 1, wherein the molecular weight of the component b-1) is between 60 to 300 g/mol.

5. The process according to claim 1, wherein the component b) further comprises component b-2).

6. The process according to claim 5, wherein the component b-2) is selected from the group consisting of a polyether alcohol and a polyester alcohol.

7. The process according to claim 5, wherein the component b) consists of components b-1) and b-2).

8. The process according to claim 1, wherein the blowing agent d) is selected from the group consisting of water and a mixture of water with one or more further chemical blowing agents.

9. The process according to claim 1, wherein the weight ratio of the cell opener e1) to the stabilizer e2) is from 0.2 to 10.

10. The process according to claim 1, wherein the open-cell rigid polyurethane foam obtained has a density of 30 to 100 g/1.

11. The process according to claim 1, wherein the reaction mixture is free foamed.

12. An open-cell rigid polyurethane foam obtainable by the process according to claim 1.

13. The open-cell rigid polyurethane foam obtainable by the process according to claim 1, having a density between 30-100 g/l.

14. A core material of a vacuum insulation panel, the core material comprising:
an open-cell rigid polyurethane foam produced by the process according to claim 1.
